(19) United States
(12) Patent Application Publication
(10) Pub. No.: US 2009/0024269 A1
(43) Pub. Date: Jan. 22, 2009

(54) METHOD FOR DETERMINING THE CENTRE OF GRAVITY FOR AN AUTOMOTIVE VEHICLE

(75) Inventors: Robert Shorten, Dublin (IE); Selim Solmaz, Maynooth (IE); Mehmet Akar, Maynooth (IE)

Correspondence Address: WITHROW & TERRANOVA, P.L.L.C., 100 REGENCY FOREST DRIVE, SUITE 160, CARY, NC, 27518, US

(73) Assignee: NATIONAL UNIVERSITY OF IRELAND MAYNOOTH, Maynooth (IE)

(21) Appl. No.: 12/202,452

(22) Filed: Sep. 2, 2008

Related U.S. Application Data
(63) Continuation-in-part of application No. PCT/EP2007/001584, filed on Feb. 23, 2007.

(30) Foreign Application Priority Data
Mar. 3, 2006 (IE) S2006/0162

(51) Int. Cl. G06F 17/00

(52) U.S. Cl. 701/29

(57) ABSTRACT

Methods for determining the height, horizontal position, and lateral position of the centre of gravity of a vehicle are disclosed. The methods comprise constructing a plurality of models of vehicle behaviour, each model including a plurality of parameters that determine vehicle behaviour including parameters that define the position of the centre of gravity. The method then measures actual vehicle behaviour during operation of the vehicle. The actual behaviour and the behaviour predicted by the models are then compared to determine which of the models most effectively predicts behaviour of the vehicle. The model that is most effective in predicting the actual behaviour of the vehicle is then assumed to include amongst its parameters an estimate of the position of the centre of gravity of the vehicle.

This application is a Continuation-in-Part of International application PCT/EP2007/001584 filed Feb. 23, 2007, which claims the benefit of Irish patent application S2006/0162 filed Mar. 3, 2006, the disclosures of which are incorporated herein by reference in their entireties.

### FIELD OF THE INVENTION

This invention relates to a method for determining the centre of gravity for an automotive vehicle. More specifically, embodiments of the invention provide a method for determining height, horizontal location and lateral position of the centre of gravity. It has particular, but not exclusive, application for use with passive and active rollover detection and prevention systems.

### BACKGROUND OF THE INVENTION

According to the United States National Highway Traffic Safety Administration, rollover accidents in the U.S., during 2002, were responsible for nearly 33% of the total passenger fatalities whereas they accounted for only 3% of the total passenger vehicle accidents. If a rollover is imminent, all automated occupant safety mechanisms must be activated in a timely manner.

The most prominent factors affecting the occurrence of a rollover of a vehicle are:
the ratio of the centre of gravity of the vehicle (CG) height to the track width of the vehicle; and
the lateral acceleration of the vehicle.

The latter can be measured using standard automotive sensor packs. However, the CG height can neither be measured online (that is to say, substantially in real time during operation of a vehicle) using known systems, nor it can be inferred easily, and is subject to variations that depend on vehicle loadings, and other factors.

In U.S. Pat. No. 6,065,558 and U.S. Pat. No. 6,263,261 each discloses a vehicle stability system that is intended to minimise the likelihood of a rollover occurring. In these systems, the CG height is assumed to be a known parameter. However, it is known to those in the technical field that the CG height can vary significantly with changing passenger and loading configurations. The variation in CG position is more significant in large vehicles such as sports utility vehicles (SUVs), vans, trucks and buses than it is in a private car. It is the view of the present applicants that a rollover mitigation controller that is designed using a single set of model parameters may be incapable of effective recovery from an impending rollover threat over a wide range of operating conditions. Alternatively, such a controller may be configured to be overly robust, with a consequential detrimental effect upon the performance of the vehicle under normal situations.

An aim of this invention is to provide a system and method to determine the CG height and the horizontal location of CG online so that they can be used for rollover detection and mitigation, and for improving lateral performance of a vehicle.

In “Measurement & Calculation of Vehicle Center of Gravity Using Portable Wheel Scales”, Nicholas Mango, SAE Paper 2004-01-1076, 2004 SAE World Congress, Detroit Mich., Mar. 8-11, 2004, there is disclosed an off-line method for determining CG position using scales. Such a method can only be done when the vehicle is stationary and is not intended for controller tuning applications.

U.S. Pat. No. 5,136,513 describes an online estimation method for CG position for use in automotive vehicles. The method requires use of a specialized sensor equipment to measure the ride height and displacement of the individual suspensions with respect to the vehicle chassis. The relative ride height differences between the front and rear axles during unloaded and loaded conditions are used to calculate an estimation of the CG position.

In EP-A-0 918 003 B1 an alternative method for estimating the height of the CG in real-time is described. The method utilizes an estimated drive/brake slip of at least one wheel using wheel speed sensors, which is used to compute the instantaneous radius of the corresponding wheel. Using this information, the angle of the corresponding wheel axle with respect to the ground is computed and then used in an equation related to the lateral dynamics of the car to compute the CG height. In a slightly different context, real-time estimation of CG position has previously been investigated by the aerospace industry. U.S. Pat. No. 4,937,754 and U.S. Pat. No. 5,034,896 describe online estimation methods of CG position for use in aeroplane flight controllers. Both described methods depend heavily on the aerodynamics of the airplanes and require the existence of flaps, horizontal stabilizers, as well as the measurements of angle of attack, engine speed and fuel mass readings and therefore aforementioned methods are different than the method described within this document. Similarly, U.S. Pat. No. 5,987,397 describes a CG position estimation algorithm system for use in helicopters based on neural networks. The estimation is performed during the first steady hovering manoeuvre and requires to be updated for the changes in the payload and the fuel mass, which are known precisely.

### SUMMARY OF THE INVENTION

This invention is based upon the observation that the handling behaviour of any vehicle depends on the location of its centre of gravity. This observation can be used to estimate the centre of gravity location in a moving vehicle as follows. First, a-priori, a range of vehicle models are constructed that reflect different uncertain vehicle parameters (centre-of-gravity, vehicle tyre parameters, suspension parameters, vehicle loading, and so forth). Then, by comparing the predicted outputs of these models (predicted lateral acceleration, roll angle, roll velocity, yaw rate or pitch) with actual sensor readings, it is possible to infer the model that most accurately reflects the vehicle dynamics. This inferred model is the one constructed from the assumed vehicle parameters that are “closest” to the unknown actual vehicle parameters. This method has a number of advantages over other estimation methods. Firstly, the unknown parameters that are allowed to have a nonlinear dependence in the current setting can be identified rapidly. Secondly, the method does not require a vast amount of output measurements before the identification can be made, which is a common feature of other online estimation methods to deal with the persistence-of-excitation concept in system identification. Thirdly, the method does not require any additional sensors other than those already found in standard commercial vehicles.

Therefore, from a first aspect, this invention provides a method of determining the position of the centre of gravity of a vehicle comprising: a. constructing a plurality of models of vehicle behaviour, each model including a plurality of known and unknown parameters that determine vehicle behaviour including unknown parameters that define the position of the centre of gravity; b. measuring vehicle behaviour during operation of the vehicle; c. comparing measured vehicle behaviour with behaviour predicted by the models; d. determining which of the models most effectively predicts behaviour of the vehicle.

Thus, once the best model has been identified, its value for the position of the centre of gravity within that model is assumed to be correct.

The models may include an unknown parameter that defines the vertical height of the centre of gravity. Alternatively or additionally, the models include an unknown parameter that defines the horizontal position of the centre of gravity. The unknown parameters may include tyre parameters and vehicle loading.

Typically, the models include at least one known parameter that defines a constant property of the vehicle. For example, these known parameters may include one or more of spring stiffness, suspension damping, track width and axle separation. In some cases, it is not possible to determine the suspension characteristics with sufficient accuracy to treat them as a known constant. Therefore, in some embodiments, spring stiffness and suspension damping are treated as unknown parameters.

In a method embodying the invention, measured vehicle behaviour is typically determined from data received from sensors deployed upon the vehicle. These may include one or more of steering angle, lateral acceleration, speed and yaw rate. They may also include roll angle and roll rate, or, alternatively, pitch angle and pitch rate (or a combination of roll and pitch parameters).

The step of comparing measured vehicle behaviour with behaviour predicted by the models may include calculating for each model an error value that quantifies the inaccuracy of the model. In such cases, determining which of the models most effectively predicts behaviour of the vehicle may include selecting the least error value.

From another aspect, the invention provides a method for determining the lateral shift of the centre of gravity of a vehicle comprising determining the height of the centre of gravity (typically, using a method according to the first aspect of the invention), measuring the roll angle offset of the vehicle and calculating the amount by which the centre of gravity must be laterally offset to produce that amount of roll. The lateral offset of the centre of gravity may be calculated as

$$y = \frac{k {φ}_{offset}}{mg cos ( {φ}_{offset} )} - h tan ( {φ}_{offset} ) .$$

The meaning of the symbols used in this formula is set forth below.

The techniques employed in the first aspect of the present invention can also be applied for determining for example, loss of pressure or excessive tread wear in an individual or a plurality of tires of an automotive vehicle in real time utilizing existing vehicular sensors.

Accordingly, in a third aspect, the invention provides a method according to claim 17.

Accordingly, in a fourth aspect, the invention provides a method according to claim 18.

These third and fourth aspects of the invention are based upon the observation that the lateral handling behaviour of any vehicle will depend on the available traction in each of the wheels, measured in terms of the tire cornering stiffness. Given certain sensory information, this observation can be used to estimate any condition that can result in a reduced cornering stiffness (i.e. reduced traction) in a moving vehicle as follows. First, a-priori, a range of vehicle models are constructed that reflect hypothetical vehicle behaviour given the different conditions in a single or a plurality of tires, where every model is driven with the same vehicle sensor measurements of steering angle and vehicle speed. Then, by comparing the predicted outputs of these models (predicted lateral acceleration, and yaw rate) with the actual sensor readings by means of a non-linear cost function, it is possible to infer the model that most accurately reflects the vehicle dynamics corresponding to the type of the tire condition in the vehicle. The inferred model is the one constructed from the assumed tire condition that has “closest” dynamics to that of the measured vehicle response. The step of comparing measured vehicle behaviour with the behaviour predicted by the models may include calculating for each model an error value that quantifies the inaccuracy of the model. In such cases, determining which of the models most effectively predicts behaviour of the vehicle may include selecting the least error value minimizing a nonlinear cost function.

Once the best model (in the sense of smallest output error) has been identified, the corresponding tire cornering stiffness distribution (or non-existence of it), as predicted by the selected model, is assumed to be correct. The constructed models may include unknown parameters that define varying levels of tire stiffness values. Alternatively or additionally, the models may be parameterised with varying levels of vehicle mass.

Particular embodiments of the invention can be implemented such that vehicle load or speed variations do not effect the tire pressure/wear monitoring functionality.

In methods embodying these aspects of the invention, measured vehicle behaviour is typically determined from data received from sensors deployed upon the vehicle. These may include one or more of steering angle, lateral acceleration, vehicle speed, and yaw rate. While it is not required for the basic functioning of the estimation method, the sensor information may also include roll angle and roll rate, or alternatively, pitch angle and pitch rate.

According to these aspects, tire conditions can be identified rapidly in real time, whenever the vehicle makes a cornering manoeuvre, where the alternative indirect tire pressure estimation systems are known to be ineffective. Also, neither method requires a vast amount of output measurement history before the identification can be made, which is a common feature of other online estimation methods to deal with the persistence-of-excitation concept in system identification.

Each of these aspects of the present invention can be implemented in conventional vehicle ECU (electronic control units) to detect, for example, over/under inflation of an individual or a plurality of tires, sudden/slow pressure drops and excessive tire thread wear, especially, in vehicles equipped with ESP (electronic stability control) or similar systems.

The specific sensor information required includes vehicle speed, lateral acceleration, steering angle and yaw rate signals, all of which are available as part of the standard vehicle lateral stability systems such as ESP (Electronic Stability Program), ESC (Electronic Stability Control), DSC (Dynamic Stability Control), VSC (Vehicle Stability Control), AdvanceTrac, Stabilitrac etc.

The information provided by the present invention can be used to issue an audio-visual signal to warn/inform the driver of the tire/tires or the axle subject to the pressure/wear defect.

Additionally or alternatively, the information can be used to issue a signal to reduce engine torque automatically in a safe and controlled manner to pre-specified levels for limiting the vehicle speed. This automatic torque reduction serves the purpose of:
indirectly warning the driver about a fault/failure in the vehicle; and/or
reducing the chances of an accident due to a tire failure, which can be induced by large wheel forces occurring at high vehicle speeds.

Alternative implementations of the invention can be used to recognize different predetermined types of wheels or tires (e.g., snow tires, tires with snow chains, space saver tires, etc.), each type having an associated model so that the vehicle can dynamically detect the type of wheels/tires attached to the vehicle. The vehicle can then issue an audio-visual signal to inform the driver of the type of wheels or tires used. Additionally or alternatively, it can be used to limit engine speed to levels that are optimal/safe for the given tire type and operating conditions.

In relation to these aspects of the present invention, one set of prior art includes “direct” tire pressure monitoring systems, which involve a sensing element that is embedded inside the tire to measure the current tire pressure levels.

For example, U.S. Pat. No. 6,300,867 discloses a spring loaded contact switch embedded into each wheel and in the event of a low tire pressure the switch closes a circuit to issue a warning signal to the driver. In U.S. Pat. No. 7,024,318 the use of wireless pressure sensors in each wheel to directly measure air pressures is detailed. In U.S. Pat. No. 7,227,458 the use of a pressure sensor along with an acceleration sensor embedded to each wheel is considered, which aims to improve the pressure sensing data. In U.S. Pat. No. 6,278,361 and U.S. Pat. No. 6,759,952 the use of radial and lateral acceleration signals along with temperature and pressure sensors on each wheel is considered, where they suggest analyzing wheel vibration and pressure data to estimate tire imbalance, tire thread wear or suspension performance. In U.S. Pat. No. 7,180,490 the use of RFID tags embedded into the tire threads along with RFID scanners outside each tire is considered to monitor thread thickness.

On the other hand, there are “indirect” tire pressure monitoring systems that involve utilizing available sensory equipment from other subsystems of the car. These systems mainly make use of the ABS (Anti Blocking System) and ESP (Electronic Stability Program) sensors.

U.S. Pat. No. 6,684,691 discloses using wheel rotation speed information from ABS system to compute the imbalance on tire pressures attached to each axle. This is achieved by calculating the distance traveled by each wheel during straight and steady speed driving conditions. US patent application no. 2007/0061100 discloses using wheel rotation analysis along with wheel vibration analysis based on the wheel speed sensors (as part of ABS) in each wheel. Wheel rotation analysis is used to estimate the running radius (and the distance traveled) for each wheel. Wheel vibration analysis is utilized to monitor time dependent variation of the rotation velocity, where the vibration frequency is heavily dependent on the pressure levels.

### BRIEF DESCRIPTION OF THE DRAWING FIGURES

An embodiment of the invention will now be described in detail, by way of example, and with reference to the accompanying drawings, in which:

FIG. 1 is a schematic diagram of a vehicle with a geometry for calculating the horizontal CG position;

FIG. 2 is a schematic description of a vehicle with a geometry for calculating CG height based on roll dynamics;

FIG. 3 shows a flow chart describing a method, being an embodiment of the invention, for calculating the horizontal CG position;

FIG. 4 shows a flow chart describing a method embodying the invention for calculating CG height based on roll dynamics;

FIG. 5 is a schematic description of a vehicle with geometry for calculating CG height based on pitch dynamics;

FIG. 6 shows a flow chart describing a method embodying the invention for calculating CG height based on pitch dynamics, and

FIG. 7 is schematic description of a vehicle with geometry for calculating lateral CG position.

FIG. 8 shows a flow chart describing a method, being a third embodiment of the invention, for calculating the tire cornering stiffness parameters.

FIG. 9 shows a flow chart describing a method, being a fourth embodiment of the invention, for recognizing possible defects compromising lateral traction in automotive tires.

FIG. 10 is a schematic diagram of a vehicle model with a specific geometry for calculating the lateral tire forces and unknown tire cornering stiffness values.

FIG. 11 illustrates various tire failure modes to be detected using the third and fourth embodiments of the invention.

FIG. 12 illustrates the nonlinear lateral tire force variation as a function of changing vertical loads and changing sideslip angles for two different tire setups.

FIG. 13 is a schematic diagram for calculating a vehicle's asymmetric steering geometry.

FIG. 14 depicts the multiple model estimation structure.

### DETAILED DESCRIPTION OF THE PREFERRED EMBODIMENTS

In the description that follows, the notation set forth below will be adopted:

| | |
|---|---|
| M | Vehicle mass. |
| g | Gravitational acceleration constant. |
| Cᵥ, Cₕ | Front and rear linear tire stiffness parameters |
| | respectively. |
| lᵥ, lₕ | Longitudinal position of CG measured from front and |
| | rear axlesrespectively. |
| L | Axle separation (L = lᵥ + lₕ). |
| T | Track width (separation between right and left wheels). |
| h | CG height measured from ground. |
| y | CG lateral position measured from the vehicle centerline. |
| k, c | Linear spring stiffness and linear viscous friction |
| | coefficients respectively representing the components |
| | of the vehicle suspension system in the roll plane. |
| b, d | Linear spring stiffness and linear viscous friction |
| | coefficients respectively representing the components |
| | of the vehicle suspension system in the pitch plane. |
| Jₓₓ, J_{yy}, | Moment of inertia of the empty vehicle about the roll, |
| J_{zz} | pitch and yaw axes respectively, and measured at the CG. |
| vₓ, v_{y} | Longitudinal and lateral velocities measured at the |
| | vehicle CG respectively. |
| β | Sideslip angle at the vehicle CG. |
| ψ | Yaw rate. |
| φ, \dot{φ} | Vehicle roll angle and roll rate, respectively. |
| θ, \dot{θ} | Vehicle pitch angle and pitch rate, respectively. |
| δ | Steering angle. |
| a_{y}, aₓ | Lateral and longitudinal accelerations in inertial |
| | coordinates, respectively. |

Among the vehicle parameters listed above, the axle separation (L), the track width (T), the moments of inertia (Jₓₓ, J_{yy}, J_{zz}) can be directly measured by the vehicle manufacturer. For simplicity of the in the context of this specification, the vehicle mass m is also assumed to be known, although the embodiment described here can be extended to deal with unknown mass.

Standard sensor packs, routinely fitted to vehicles, are used to measure the lateral acceleration a_{y}, the steering angle δ, the velocity vₓ, and the yaw rate \dot{ψ}. It is also assumed that sensors to measure roll angle φ and pitch angle θ are available on the vehicle. Even if such a sensor is not provided as standard equipment, an electrolytic roll angle sensor can be implemented at minimal cost overhead (as contrasted with popular gyroscopic roll rate sensors proposed for anti-rollover systems). As an alternative, spring displacement sensors, commonly provided in SUV type vehicles, can also be used to obtain the roll and pitch angle information.

An aim of the embodiment is to provide an arrangement for determining the longitudinal centre of gravity (lᵥ), CG height (h) and lateral CG position (y). The parameters Cᵥ, Cₕ, k, c, b, and d are also assumed to be unknown. The embodiment relies on the assumption that there exist compact intervals [symbol] [symbol] such that Cᵥε [symbol] Cₕε [symbol] kε [symbol] cε [symbol] hε [symbol] bε [symbol] and dε

[symbol]

Operation of the embodiment will now be described.

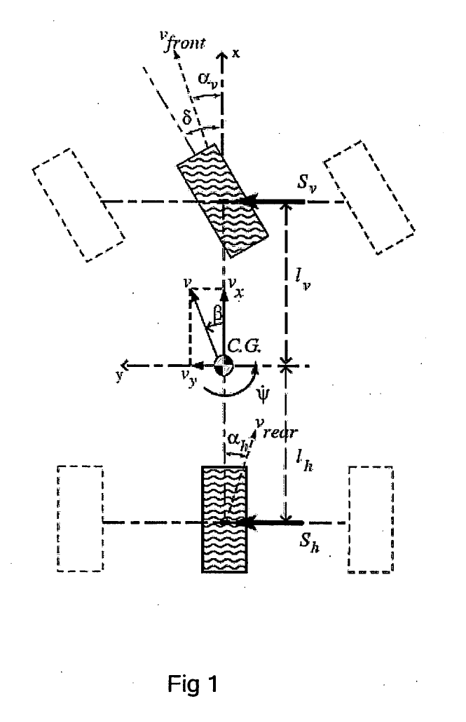

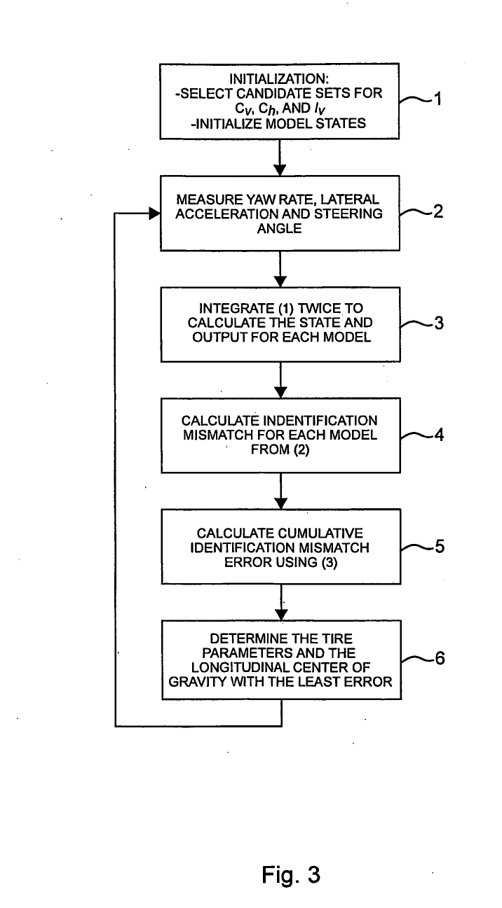

FIG. 3 shows a flow chart describing a method for calculating the longitudinal CG location lᵥ and the tyre stiffness parameters Cᵥ and Cₕ. This method will now be described with reference to FIG. 1.

In Step 1 of FIG. 3, candidate values for lᵥ and the tyre stiffness parameters Cᵥ and Cₕ are selected. To this end, let the true (and initially unknown) values for lᵥ, Cᵥ and Cₕ belong to the sets: [symbol] ={lᵥₗ, lᵥ₂, . . . , l_{vP}}, [symbol] ={Cᵥ₁, Cᵥ₂, . . . , C_{vQ}}, and [symbol] ={Cₕ₁, Cₕ₂, . . . , C_{hR}}, respectively. Note that estimates of these sets can be obtained using numerical simulations or field tests. In method step 1, we also construct N=P×Q×R models whose state variables are βᵢ, and \dot{ψ}ᵢ. Furthermore, the method sets β(0)=0 and \dot{ψ}ᵢ(0)=0, where i=1, 2, . . . , N.

In Step 2 of the method illustrated in FIG. 3, the steering angle δ, the lateral acceleration a_{y}, and the yaw rate \dot{ψ} are measured using the available sensors.

In method Step 3 of FIG. 3, the steering angle δ is used to calculate (βᵢ(t), \dot{ψ}ᵢ(t), a_{y,i}(t)) for each model:

$${\dot{β}}_{i} = \frac{{C}_{vq} + {C}_{hr}}{{mv}_{x}} {β}_{i} + ( \frac{{C}_{hr} {l}_{hp} - {C}_{vq} {l}_{vp}}{{mv}_{x}^{2}} - 1 ) {\dot{ψ}}_{i} + \frac{{C}_{vq}}{{mv}_{x}} δ , \\ {\ddot{ψ}}_{i} = \frac{{C}_{hr} {l}_{hp} - {C}_{vq} {l}_{vp}}{{J}_{zz}} {β}_{i} - \frac{{C}_{vq} {l}_{vp}^{2} + {C}_{hr} {l}_{hp}^{2}}{{J}_{zz} {v}_{x}} {\dot{ψ}}_{i} + \frac{{C}_{vq} {l}_{vp}}{{J}_{zz}} δ , \\ {a}_{y , i} = \frac{{C}_{vq} + {C}_{hr}}{m} {β}_{i} + \frac{{C}_{hr} {l}_{hp} - {C}_{vq} {l}_{vp}}{{mv}_{x}} {\dot{ψ}}_{i} + \frac{{C}_{vq}}{{mv}_{x}} δ \qquad ( 1 )$$

where i=(p−1)P+(q−1)Q+(r−1)R+1 denotes the model number with the parameters (lᵥₚ, C_{vq}, Cₕᵣ) for p=1, 2, . . . , P, q=1, 2 . . . , Q, r=1, 2, . . . , R; (βᵢ(t), \dot{ψ}ᵢ(t)) is the state for the i-th model; and lₕₚ=L−lᵥₚ.

In method Step 4 of FIG. 3, the identification error eᵢ(t) corresponding to the i-th model is calculated using equation 2.

$${e}_{i} ( t ) = [ \begin{matrix}{a}_{y} ( t ) - {a}_{y , i} ( t ) \\ \dot{ψ} ( t ) - {\dot{ψ}}_{i} ( t )\end{matrix} ] , \\ i = 1 , 2 , … , N \qquad ( 2 )$$

In method Step 5 of FIG. 3, the cumulative identification error Jᵢ(t) corresponding to the i-th model is calculated using Equation (3)

$${J}_{i} ( t ) = ζ {‖ {e}_{i} ( t ) ‖}^{2} + γ {\int }_{0}^{t} {e}^{- λ ( t - τ )} {‖ {e}_{i} ( t ) ‖}^{2} d t , \qquad ( 3 )$$

where ζ, γ, and λ are non-negative design parameters which can be appropriately chosen to weigh instantaneous and steady-state identification errors.

In method Step 6 of FIG. 3, the model with the least cumulative identification error is calculated using

i*=arg_{i=1, . . . , N}minJᵢ(t) (4)

and the corresponding parameter values (lᵥₚ, C_{vq}, Cₕᵣ) are obtained.

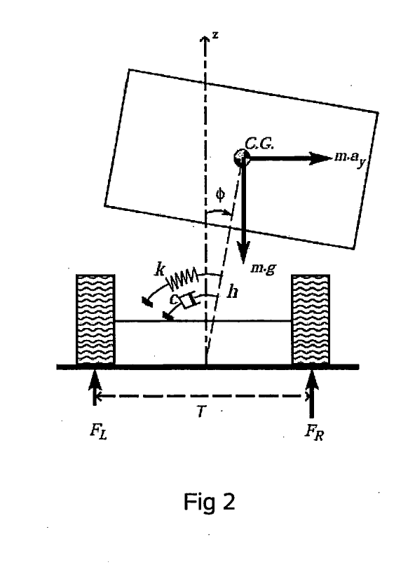

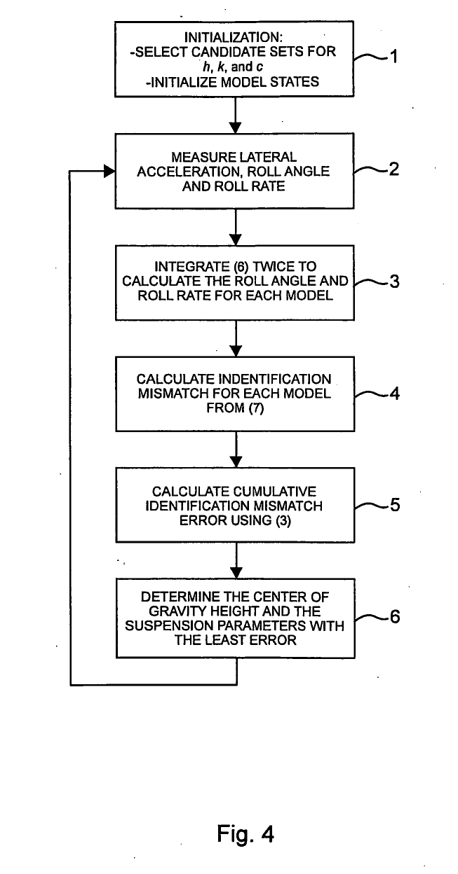

FIG. 4 shows a flow chart describing a method for calculating the CG height h and linear suspension parameters k and c of the roll plane, which can be used for rollover detection and prevention schemes. This method will now be described with reference to FIG. 2.

In method step 1, sets of candidate values for h, k, and c are selected. To this end, let the true values for h, k and c belong to the sets [symbol] ={h₁, h₂, . . . , h_{P}}, [symbol] ={k₁, k₂, . . . , k_{Q}}, and [symbol] ={c₁, c₂, . . . , c_{R}}, respectively. Similar to the calculation of the longitudinal centre of gravity, estimates of these sets can be obtained through numerical simulations or field tests.

One embodiment of the invention relies on the assumptions that the exact value of the spring stiffness k is available and there exist constant, measurable steady-state values, φₛₛ and a_{y,ss}, of the roll angle φ and the lateral acceleration a_{y}, respectively. In this case, the CG height can be calculated from Equation (5).

$$h = \frac{k {φ}_{ss}}{m ( g {φ}_{ss} + {a}_{y , ss} )} \qquad ( 5 )$$

Although this method will work under specific manoeuvre and loading conditions, the variability in the suspension system requires accurate estimate of the spring stiffness. Such an estimate may not be available. Therefore the embodiment of the present invention described with reference to FIG. 4 assumes that this is a variable.

In method Step 1 of FIG. 4, we construct N=P×Q×R models whose state variables are φᵢ and \dot{φ}ᵢ for i=1, 2, . . . , N. Furthermore, we set φᵢ(0)=0, and \dot{ψ}ᵢ(0)=0 for i=1, 2, . . . , N.

In method Step 2 of FIG. 4, the lateral acceleration a_{y}, the roll angle φ, and the roll rate \dot{φ} are measured using vehicle sensors.

In method Step 3 of FIG. 4, the lateral acceleration a_{y} is used to integrate twice the following equation for each model

$${\ddot{φ}}_{i} = \frac{{k}_{q} - {mgh}_{p}}{{J}_{xx} + {mh}_{p}^{2}} {φ}_{i} - \frac{{c}_{r}}{{J}_{xx} + {mh}_{p}^{2}} {\dot{φ}}_{i} + \frac{{mh}_{p}}{{J}_{xx} + {mh}_{p}^{2}} {a}_{y} , \qquad ( 6 )$$

to calculate φᵢ(t) and \dot{φ}ᵢ(t) where i=(p−1)P+(q−1)Q+(r−1)R+1 denotes the model number with the parameters (hₚ, k_{q}, Cᵣ) for p=1, 2, . . . , P, q=1, 2, . . . , Q, and r=1, 2, . . . , R.

In method Step 4 of FIG. 4, the identification error eᵢ(t) corresponding to the i-th model is calculated using Equation (7)

$${e}_{i} ( t ) = [ \begin{matrix}φ ( t ) - {φ}_{i} ( t ) \\ \dot{φ} ( t ) - {\dot{φ}}_{i} ( t )\end{matrix} ] , \\ i = 1 , 2 , … , N \qquad ( 7 )$$

In method Step 5 of FIG. 4, the cumulative identification error Jᵢ(t) corresponding to the i-th model is calculated using Equation (3) with eᵢ from Equation (7).

In method Step 6 of FIG. 4, the model with the least cumulative identification error is calculated using

i*=arg_{t=1, . . . , N}minJᵢ(t), (8)

and the corresponding parameter values (hₚ, k_{q}, cᵣ) are obtained.

In another embodiment of the present invention, the method in FIG. 4 can be extended to deal with mass variability by incorporating additional models in equation (6). To this end, the method first determines a set [symbol] ={m₁, m₂, . . . , m_{M}} denoting the mass variations of interest. For example, m₁ may denote the weight of the vehicle with one passenger, m₂ with two passengers, and so forth. Then, the models described in Equation (6) are modified to take variable mass into account, and the method represented in FIG. 4 is applicable. The same extension can be made to the method described in FIG. 3.

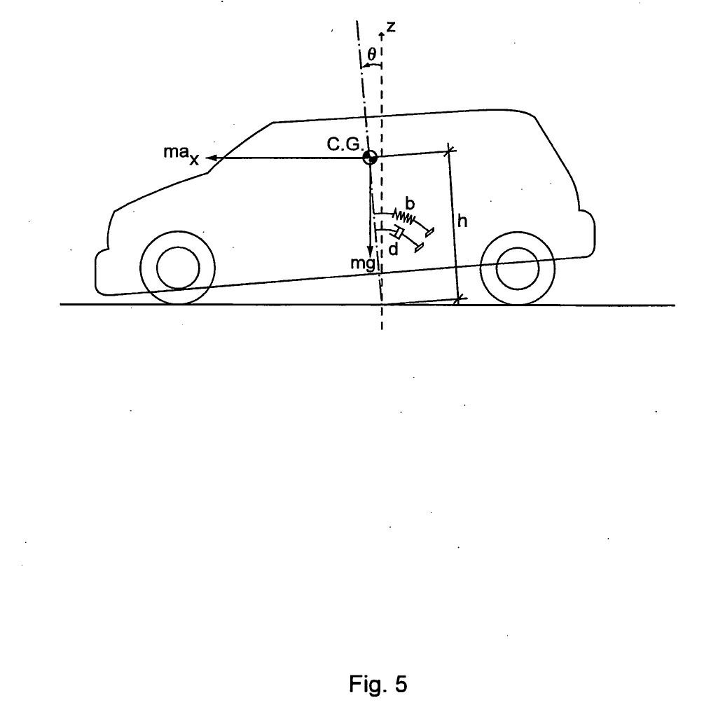

An alternative embodiment of the invention can be used to determine the CG height using longitudinal dynamics in the pitch plane during acceleration and deceleration phase of the vehicle, which is shown in FIG. 5.

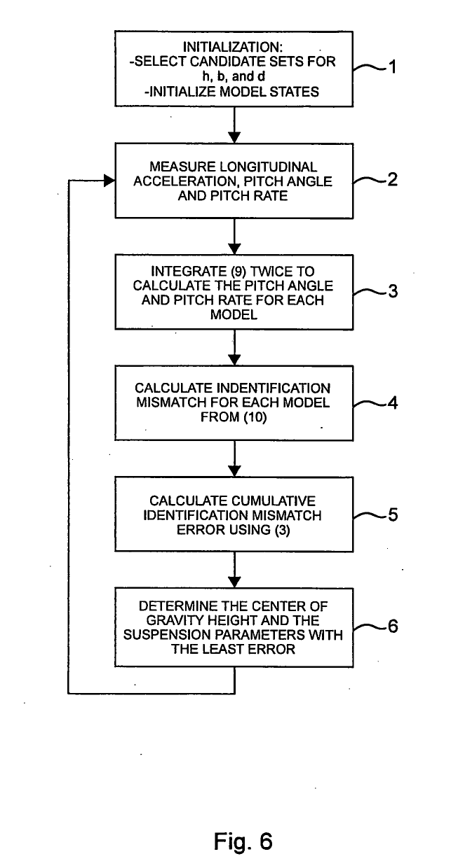

FIG. 6 shows a flow chart describing a method for calculating the CG height h and linear suspension parameters b and d of the pitch plane. This method will now be described.

In method step 1, sets of candidate values for h, b, and d are selected. To this end, let the true values for h, b and d belong to the sets [symbol] ={h₁, h₂, . . . , h_{P}}, [symbol] ={b₁, b₂, . . . , b_{Q}}, and [symbol] ={d₁, d₂, . . . d_{R}}, respectively. Similar to the calculation of the longitudinal centre of gravity, estimates of these sets can be obtained through numerical simulations or field tests.

In method Step 1 of FIG. 6, we construct N=P×Q×R models whose state variables are θᵢ and \dot{θ}ᵢ for i=1, 2, . . . , N. Furthermore, we set θᵢ(0)=0, and \dot{θ}ᵢ(0)=0 for i=1, 2, . . . , N.

In method Step 2 of FIG. 6, the longitudinal acceleration aₓ, the pitch angle θ, and the pitch rate \dot{θ} are measured using vehicle sensors.

In method Step 3 of FIG. 6, the longitudinal acceleration aₓ is used to integrate twice the following equation for each model

$${\ddot{θ}}_{i} = \frac{{b}_{q} - {mgh}_{p}}{{J}_{yy} + {mh}_{p}^{2}} {θ}_{i} - \frac{{d}_{r}}{{J}_{yy} + {mh}_{p}^{2}} {\dot{θ}}_{i} + \frac{{mh}_{p}}{{J}_{yy} + {mh}_{p}^{2}} {a}_{x} , \qquad ( 9 )$$

to calculate θᵢ(t) and \dot{θ}ᵢ(t) where i=(p−1)P+(q−1)Q+(r−1)R+1 denotes the model number with the parameters (hₚ, b_{q}, dᵣ) for p=1, 2, . . . , P, q=1, 2, . . . , Q, and r=1, 2, . . . , R.

In method Step 4 of FIG. 6, the identification error eᵢ(t) corresponding to the i-th model is calculated using Equation (7)

$${e}_{i} ( t ) = [ \begin{matrix}θ ( t ) - {θ}_{i} ( t ) \\ \dot{θ} ( t ) - {\dot{θ}}_{i} ( t )\end{matrix} ] , \\ i = 1 , 2 , … , N \qquad ( 10 )$$

In method Step 5 of FIG. 6, the cumulative identification error Jᵢ(t) corresponding to the i-th model is calculated using Equation (3) with eᵢ from Equation (10).

In method Step 6 of FIG. 6, the model with the least cumulative identification error is calculated using

i*=arg_{i=1, . . . , N}minJ(t), (11)

and the corresponding parameter values (hₚ, b_{q}, dᵣ) are obtained.

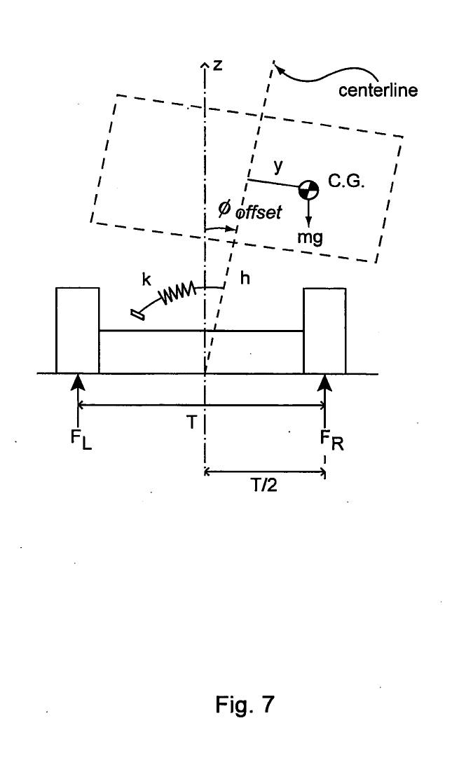

A further embodiment of the invention can be used to calculate the lateral shift of the CG position with respect to the vehicle centreline. This method relies on the assumption that the exact value of the spring stiffness k, and CG height h are available, which is obtainable through the CG height estimation method using roll plane dynamics described above. This embodiment is intended for straight, steady-state driving conditions and is based on the fact that a lateral shift of CG position relative to the vehicle centreline causes a lateral load transfer and a consequential offset in the roll angle, which we denote by φ_{offset} and assume that it is measured. The schematic of static system for this specific method is shown in FIG. 7. In this case, the lateral position of the CG can be calculated from Equation (12)

$$y = \frac{k {φ}_{offset}}{mg cos ( {φ}_{ffset} )} - h tan ( {φ}_{ffset} ) . \qquad ( 12 )$$

The techniques employed in the first aspect of the present invention can also be applied for determining the loss of pressure or excessive tread wear in an individual or a plurality of tires for an automotive vehicle in real time utilizing existing vehicular sensors.

In the description of these embodiments, the following additional notation will be adopted:

| | |
|---|---|
| Cᵥₗ, Cᵥᵣ | Front-left and front-right linear tire stiffness parameters, |
| | respectively. |
| Cₕₗ, Cₕᵣ | Rear-left and rear-right linear tire stiffness parameters, |
| | respectively. |
| F_{Zvl}, F_{Zvr} | Front-left and front-right vertical tire forces, respectively. |
| F_{Zhl}, F_{Zhr} | Rear-left and rear-right vertical tire forces, respectively. |
| Sᵥₗ, Sᵥᵣ | Front-left and front-right lateral tire forces, respectively. |
| Sₕₗ, Sₕᵣ | Rear-left and rear-right lateral tire forces, respectively. |
| αᵥₗ, αᵥᵣ | Front-left and front-right tire sideslip angles, respectively. |
| αₕₗ, αₕᵣ | Rear-left and rear-right tire sideslip angles, respectively. |
| v | Horizontal velocity measured at the vehicle CG. |
| δᵢₙₙₑᵣ, | Inner and outer steering angles at the front tires, respectively. |
| δₒᵤₜₑᵣ | |

As in the first embodiment, standard sensor packs, routinely fitted to vehicles as part of lateral & yaw stability control systems (e.g. ESP), can be employed to implement the third and fourth embodiments of the invention. Then given some further calculated parameters, more detailed and accurate vehicle models can be employed to determine additional aspects of vehicle behaviour.

In each of the third and fourth embodiments, the estimation of CG position (i.e., lᵥ, lₕ and h) can be determined, for example, in accordance with the first embodiment.

An aim of the third embodiment is to provide an arrangement for dynamically determining the individual tire cornering stiffness values Cᵥₗ, Cᵥᵣ, Cₕₗ, Cₕᵣ for each of the four tires of a vehicle. In the present implementation, parameters Cᵥₗ, Cᵥᵣ, Cₕₗ, Cₕᵣ are assumed to be unknown but their maximum stiffness values are known. The third embodiment relies on the assumption that when and if any of the tire cornering stiffness values are found to be smaller by a certain threshold level, then the corresponding tires must either have non-optimal pressure (under/over inflation) and/or reduced thread depth. Moreover, in order to account for the changeability in tire cornering stiffness thresholds for each tire, certain compact intervals [symbol] containing finite number of grid points can be defined such that, in each respective parameter set the grid points satisfy Cᵥₗε [symbol] Cᵥᵣε [symbol] Cₕₗε [symbol] and Cₕᵣε [symbol] Moreover, these finite number grid points can be used to parameterize identification models, as will be described below, which can be used to recognize/estimate varying levels of tire pressure/thread depth failure. Note that the compact intervals [symbol] represent the relationship between tire pressure (and/or thread depth loss) versus tire stiffness variation, and these can be obtained using field tests or tire test rig evaluations.

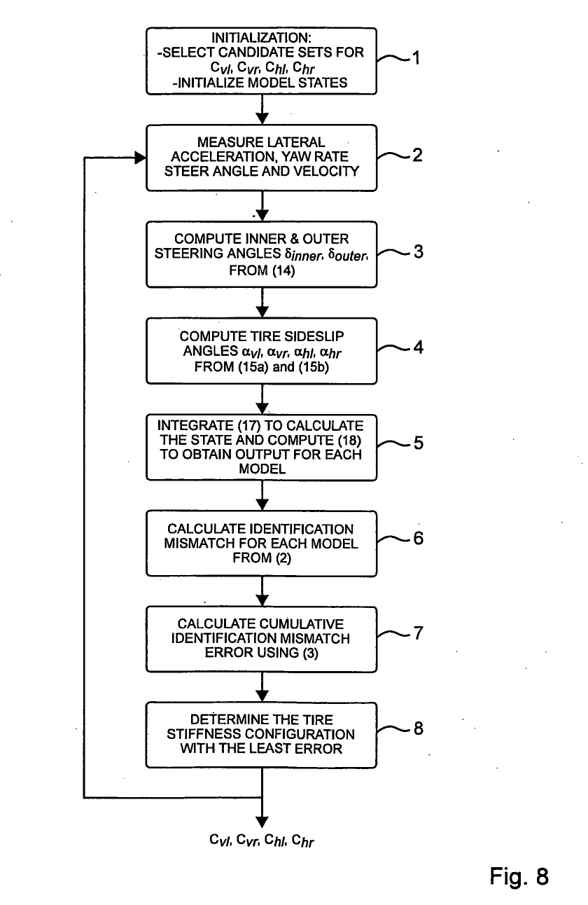

Referring now to FIG. 8 which shows a flow chart describing an indirect estimation method based on lateral dynamics measurements for calculating cornering stiffness parameters Cᵥₗ, Cᵥᵣ, Cₕₗ, Cₕᵣ.

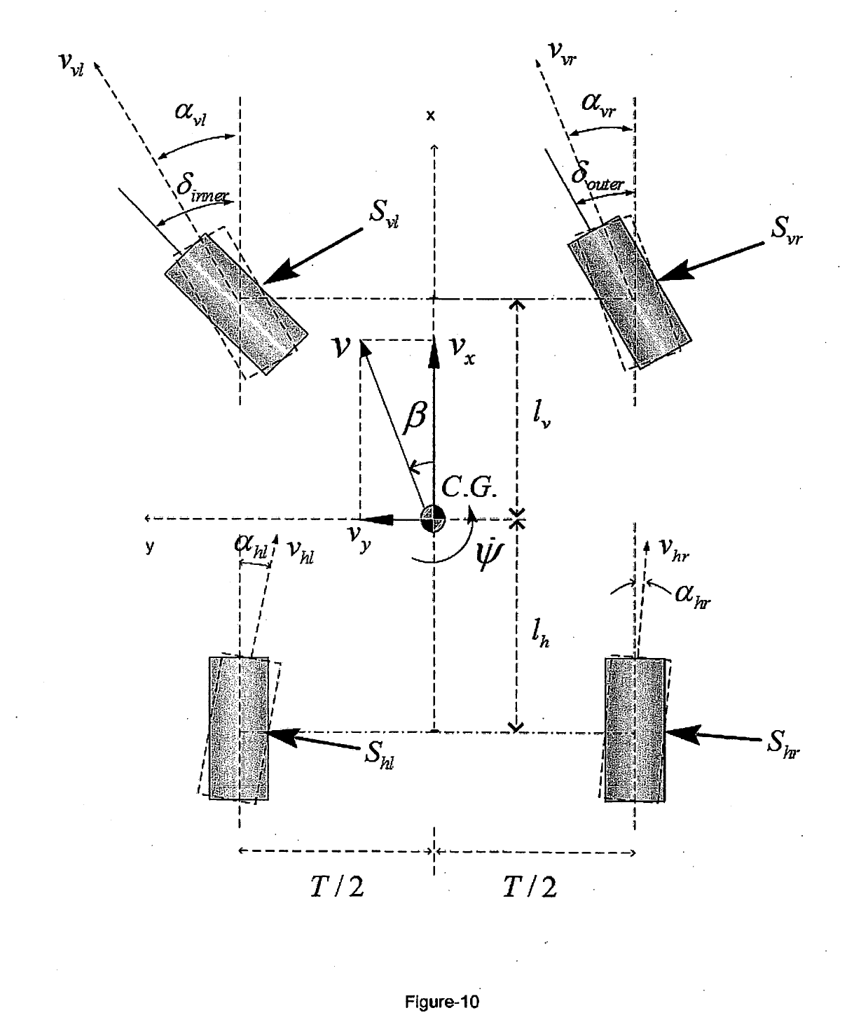

FIG. 10 depicts a nonlinear model structure of the lateral dynamics of an automotive vehicle, which is utilized for the identification models. Assuming linear tire forces as a function of tire side slip angles, the dynamic model based on FIG. 10 is as follows:

$$\dot{β} = \frac{1}{{mv}_{x}} [ {C}_{vl} {α}_{vl} + {C}_{vr} {α}_{vr} + {C}_{hl} {α}_{hl} + {C}_{hr} {α}_{hr} ] - \dot{ψ} \\ \ddot{ψ} = \frac{1}{{J}_{zz}} [ ( {C}_{vl} {α}_{vl} + {C}_{vr} {α}_{vr} ) {l}_{v} - ( {C}_{hl} {α}_{hl} + {C}_{hr} {α}_{hr} ) {l}_{h} ] \qquad ( 13 )$$

In Step 1 of FIG. 8, candidate values/grid-points for Cᵥₗ, Cᵥᵣ, Cₕₗ, Cₕᵣ are selected such that each corresponding set of values belong the compact intervals [symbol] To this end, let the true (and initially unknown) cornering stiffness values belong to the following sets: [symbol] ={Cᵥₗ_{_{—}}₁, Cᵥₗ_{_{—}}₂, . . . , Cᵥₗ_{_{—}}_{P}}, [symbol] ={Cᵥᵣ_{_{—}}₁, Cᵥᵣ_{_{—}}₂, . . . , Cᵥᵣ_{_{—}}_{Q}}, [symbol] ={Cₕₗ_{_{—}}₁, Cₕₗ_{_{—}}₂, . . . , Cₕₗ_{_{—}}_{R}}, and [symbol] ={Cₕᵣ_{_{—}}₁, Cₕᵣ_{_{—}}₂, . . . , Cₕᵣ_{_{—}}_{S}}, respectively. In step 1 of FIG. 8, we construct N=P×Q×R×S models a-priori, whose state variables are βᵢ and \dot{ψ}ᵢ, and where i=1, 2, . . . , N. Furthermore, the method assumes zero initial conditions for each identification model, that is βᵢ=0 and \dot{ψ}ᵢ(0)=0 for each iε{1, 2, . . . , N}.

In Step 2 of FIG. 8, the steering angle δ, the vehicle velocity vₓ, the lateral acceleration a_{y}, and the yaw rate \dot{ψ} are measured using the available sensors.

In Step 3 of FIG. 8, the steering column angle δ is used to compute the asymmetric steering angles for the inner and outer front wheels δᵢₙₙₑᵣ and δₒᵤₜₑᵣ respectively, as follows

$${δ}_{inner} = {δ}^{2} \frac{T}{2 L} - δ , \\ and \\ {δ}_{outer} = δ - {δ}^{2} \frac{T}{2 L} \qquad ( 14 )$$

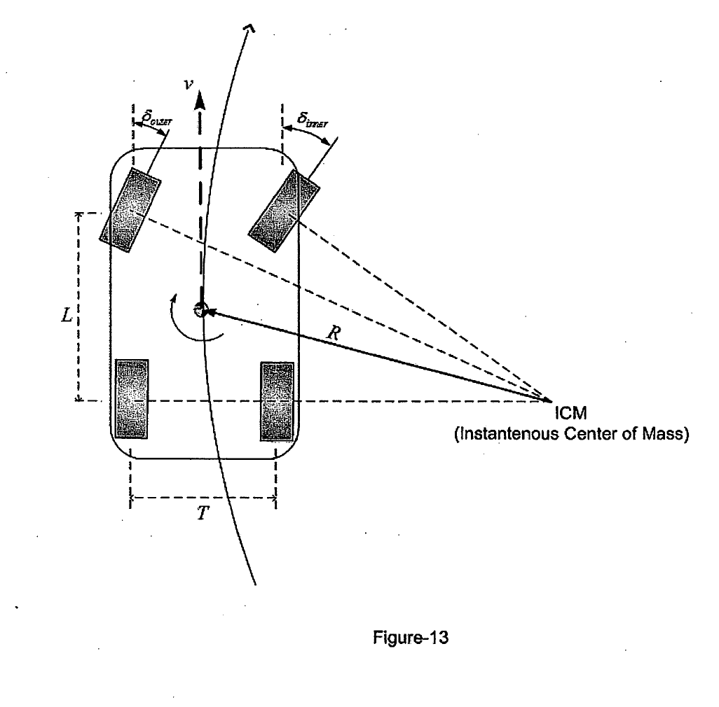

which are obtained with reference to FIG. 13. We note that the expressions (14) are based on a simplified model for the rotation of the front wheels depicted on FIG. 13. Nonetheless, it will be appreciated that it is possible to compute the asymmetric steering angles using alternative, more complicated steering geometries, or utilizing lookup tables based on real measurements.

In Step 4 of FIG. 8, the inner and outer steering angles δᵢₙₙₑᵣ and δₒᵤₜₑᵣ, the vehicle velocity vₓ, and the yaw rate \dot{ψ} are used to compute the tire sideslip angles at each wheel depending on the turning direction as follows:

$$\begin{matrix}\begin{matrix}if turning left \\ ( i . e . , δ > 0 )\end{matrix} \{ \begin{matrix}{α}_{vl} = {δ}_{inner} - arctan ( \frac{{v}_{x} β + \dot{ψ} {l}_{v}}{{v}_{x} - 0.5 \dot{ψ} T} ) \\ {α}_{vr} = {δ}_{outer} - arctan ( \frac{{v}_{x} β + \dot{ψ} {l}_{v}}{{v}_{x} + 0.5 \dot{ψ} T} ) \\ {α}_{hl} = - arctan ( \frac{{v}_{x} β - \dot{ψ} {l}_{h}}{{v}_{x} - 0.5 \dot{ψ} T} ) \\ {α}_{hr} = - arctan ( \frac{{v}_{x} β - \dot{ψ} {l}_{h}}{{v}_{x} + 0.5 \dot{ψ} T} )\end{matrix} & ( 15 a ) \\ \begin{matrix}if turning right \\ ( i . e . , δ < 0 )\end{matrix} \{ \begin{matrix}{α}_{vl} = {δ}_{outer} - arctan ( \frac{{v}_{x} β + \dot{ψ} {l}_{v}}{{v}_{x} - 0.5 \dot{ψ} T} ) \\ {α}_{vr} = {δ}_{inner} - arctan ( \frac{{v}_{x} β + \dot{ψ} {l}_{v}}{{v}_{x} + 0.5 \dot{ψ} T} ) \\ {α}_{hl} = - arctan ( \frac{{v}_{x} β - \dot{ψ} {l}_{h}}{{v}_{x} - 0.5 \dot{ψ} T} ) \\ {α}_{hr} = - arctan ( \frac{{v}_{x} β - \dot{ψ} {l}_{h}}{{v}_{x} + 0.5 \dot{ψ} T} )\end{matrix} & ( 15 b )\end{matrix}$$

In equations (15a) and (15b) the measurement of the vehicle sideslip angle β can be obtained using the available measurements from:

$$β ( t ) = {\int }_{0}^{t} ( \frac{{a}_{y} ( τ )}{v ( τ )} - \dot{ψ} ( τ ) ) d τ \qquad ( 16 )$$

Alternatively, state observers can also be used to obtain an estimate of β to use in conjunction with tire slip calculations in (15a) and (15b).

In Step 5 of FIG. 8, the vehicle velocity vₓ, and the yaw rate \dot{ψ} are used to calculate βᵢ(t), \dot{ψ}ᵢ(t) for each model from:

$$\dot{{β}_{i}} = \frac{1}{{mv}_{x}} [ {C}_{vl\_p} {α}_{vl} + {C}_{vr\_q} {α}_{vr} + {C}_{hl\_r} {α}_{hl} + {C}_{hr\_s} {α}_{hr} ] - \dot{{ψ}_{i}} \\ {\ddot{ψ}}_{i} = \frac{1}{{J}_{zz}} [ ( {C}_{vl\_p} {α}_{vl} + {C}_{vr\_q} {α}_{vr} ) {l}_{v} - ( {C}_{hl\_r} {α}_{hl} + {C}_{hr\_s} {α}_{hr} ) {l}_{h} ] \qquad ( 17 )$$

where (βᵢ(t), \dot{ψ}ᵢ(t)) is the state for the i-th model. Using (17) one can further compute the lateral acceleration output a_{y,i}(t) corresponding to each model from:

$${a}_{y , i} = \frac{1}{m} [ {C}_{vl\_p} {α}_{vl} + {C}_{vr\_q} {α}_{vr} + {C}_{hl\_r} {α}_{hl} + {C}_{hr\_s} {α}_{hr} ] \qquad ( 18 )$$

where \dot{ψ} denotes the model number with the parameters (Cᵥₗ_{_{—}}ₚ, Cᵥᵣ_{_{—}}_{q}, Cₕₗ_{_{—}}ᵣ, Cₕᵣ_{_{—}}ₛ) and where the indices p, q, r, s are defined as p=1, 2, . . . , P; q=1, 2, . . . , Q; r=1, 2, . . . , R; and s=1, 2, . . . , S.

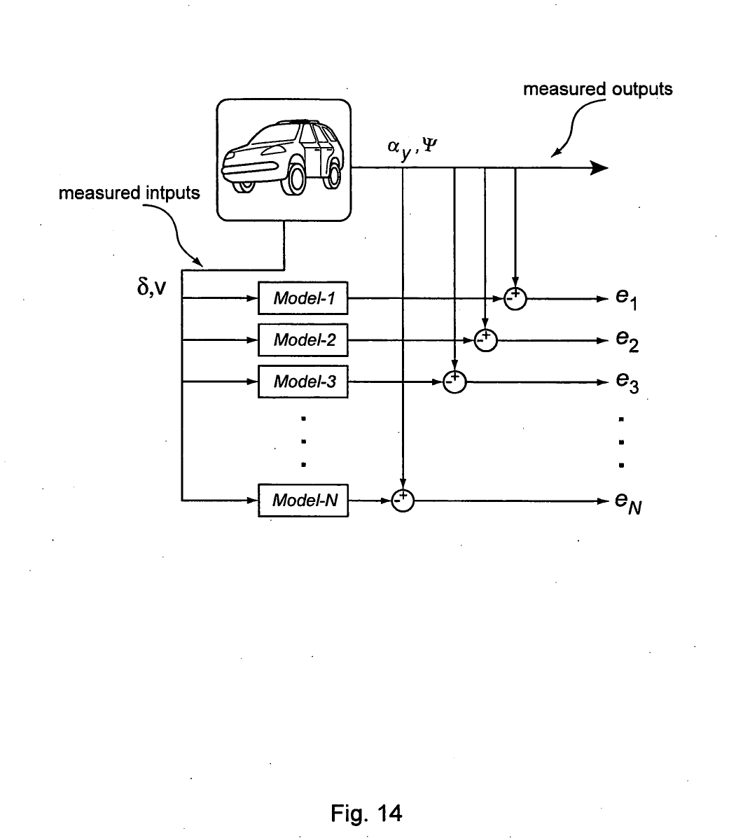

In Step 6 of FIG. 8, the identification error eᵢ(t) corresponding to the i-th model is calculated using equation (2) from the first embodiment, where the multiple model estimation structure to compute eᵢ(t) is depicted in FIG. 14.

In Step 7 of FIG. 8, the cumulative identification error Jᵢ(t) corresponding to the i-th model identification error is calculated using Equation (3) from the first embodiment, where ζ, γ, and λ are non-negative design parameters which can be appropriately chosen to weigh instantaneous and steady-state identification errors.

In Step 8 of FIG. 8, the model with the least cumulative identification error is calculated using equation (4) of the first embodiment and the corresponding parameter values (Cᵥₗ_{_{—}}ₚ, Cᵥᵣ_{_{—}}_{q}, Cₕₗ_{_{—}}ᵣ, Cₕᵣ_{_{—}}ₛ) are obtained.

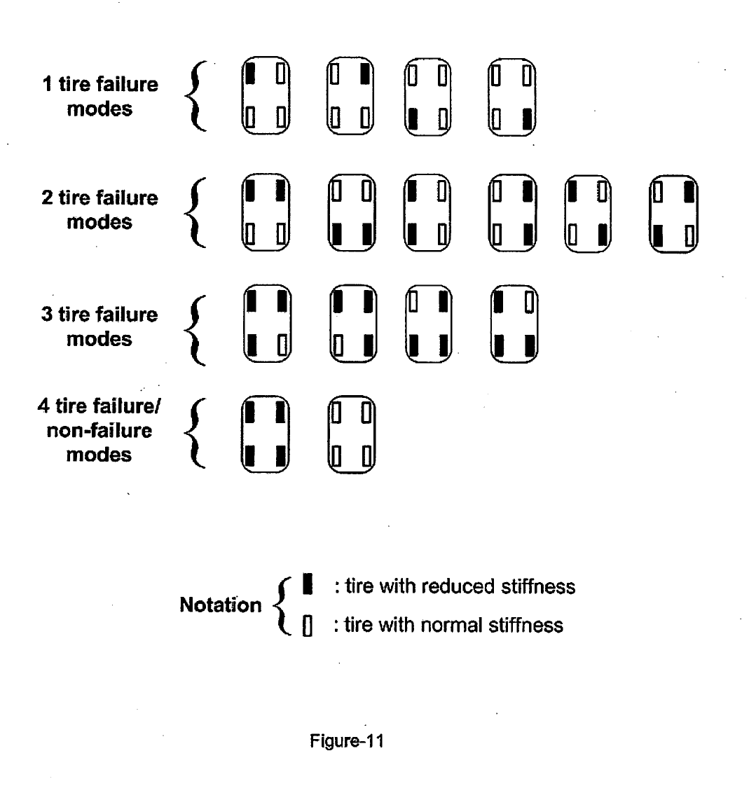

In the most basic implementation of the method depicted in FIG. 8, the models are constructed to detect a fixed and predetermined level of stiffness reduction in any combinations of the tires. In this case, one needs a minimum of 16 models which correspond to all different combinations of tire failures (in the predetermined levels) in each of the tires; this is illustrated in FIG. 11. Note that this case can be obtained in steps (5)-(8) by setting P=Q=R=S=2.

In a further embodiment, a varying number of stiffness thresholds can be implemented in conjunction with the method such that Cᵥₗε [symbol] Cᵥᵣε [symbol] Cₕₗε [symbol] and Cₕᵣε [symbol] as described in steps (5)-(8) above.

An aim of the fourth embodiment is to provide an arrangement for dynamically determining the individual tire cornering stiffness values Cᵥₗ, Cᵥᵣ, Cₕₗ, Cₕᵣ for each of the four tires, taking into account time variations in the vertical loads F_{Zvl}, F_{Zvr}, F_{Zhl}, F_{Zhr} on each tire.

To begin, the side force acting on each tire Sᵢⱼ, where the first index i={v,h} denotes “front” and “rear”, and second index j={l,r} denotes “left” and “right”, is given by:

Sᵢⱼ=Cᵢⱼ(F_{Zij})αᵢⱼ, where i={v,h} and j={l,r} (19)

where αᵢⱼ is the side slip angle of the corresponding tires and tire stiffnesses Cᵢⱼ(F_{Zij}) are time-varying functions of the corresponding vertical forces.

As in the third embodiment, tire cornering stiffness parameters Cᵢⱼ(F_{Zij}) are assumed to be unknown but their nominal values corresponding to manufacturer-recommended pressure levels and for varying vertical loads are known. Again, this embodiment relies on the assumption that when and if any of the time-varying tire cornering stiffness values (and effectively the corresponding lateral forces) are found to be smaller than nominal levels by a certain threshold amount, then the corresponding tires must either have a non-optimal pressure (i.e., under/over inflation) and/or a persistent loss of grip as a result of reduced thread depth. Note that the variation of the tire cornering stiffness with respect to loss of inflation pressure or loss of tire thread depth will vary between different tire types, but these can be measured off-line by tire manufacturers through test rig evaluations.

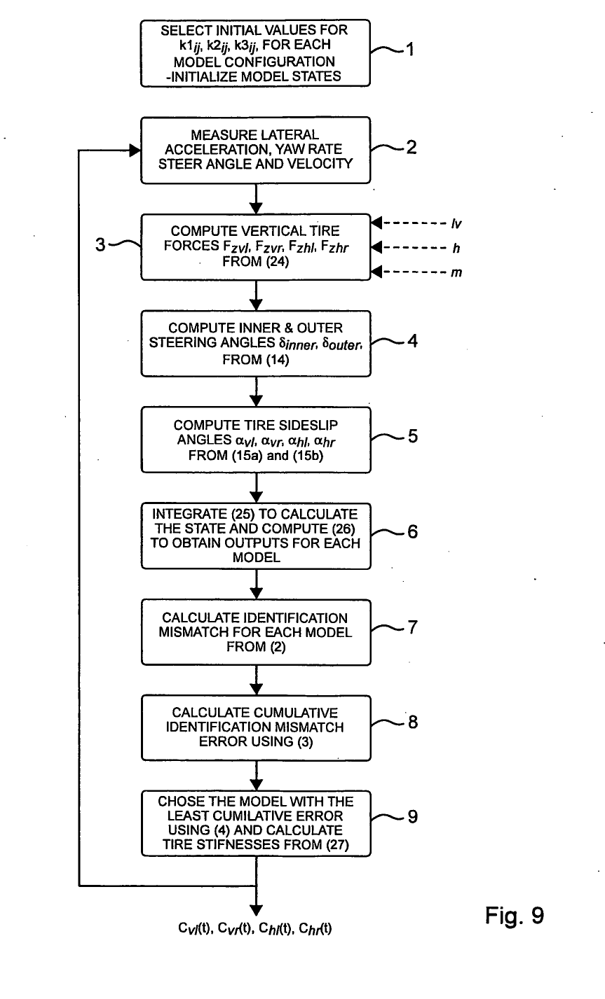

Referring now to FIG. 9 which shows a functional block diagram describing an indirect estimation method based on lateral dynamics measurements for calculating lateral tire forces and the corresponding cornering stiffness parameters Cᵥₗ(F_{Zvl}), Cᵥᵣ(F_{Zvr}), Cₕₗ(F_{Zhl}), Cₕᵣ(F_{Zhr}).

Assuming constant vehicle speed v and a small steering angle, then the dynamic model based on FIG. 10 is as follows:

$$\dot{β} = \frac{1}{mv} [ {S}_{vl} + {S}_{vr} + {S}_{hl} + {S}_{hr} ] - \dot{ψ} \\ \ddot{ψ} = \frac{1}{{J}_{zz}} [ ( {S}_{vl} + {S}_{vr} ) {l}_{v} - ( {S}_{hl} + {S}_{hr} ) {l}_{h} ] \qquad ( 20 )$$

Note here that Sᵢⱼ are non-linear functions of corresponding vertical tire forces F_{Zij} and tire sideslip angles as described in equation (21):

$$\begin{matrix}{S}_{vl} = ( {k}_{1 vl} - \frac{{F}_{Zvl}}{{k}_{2 vl}} ) {F}_{Zvl} arctan ( {k}_{3 vl} {α}_{vl} ) \\ {S}_{vr} = ( {k}_{1 vr} - \frac{{F}_{Zvr}}{{k}_{2 vr}} ) {F}_{Zvr} arctan ( {k}_{3 vr} {α}_{vr} ) \\ {S}_{hl} = ( {k}_{1 hl} - \frac{{F}_{Zhl}}{{k}_{2 hl}} ) {F}_{Zhl} arctan ( {k}_{3 hl} {α}_{hl} ) \\ {S}_{hr} = ( {k}_{1 hr} - \frac{{F}_{Zhr}}{{k}_{2 hr}} ) {F}_{Zhr} arctan ( {k}_{3 hr} {α}_{hr} )\end{matrix} \} \qquad ( 21 )$$

The lateral tire model suggested in equation (21) is provided for exemplary purposes only and it will be appreciated that other alternative models can be used within the scope of the present invention.

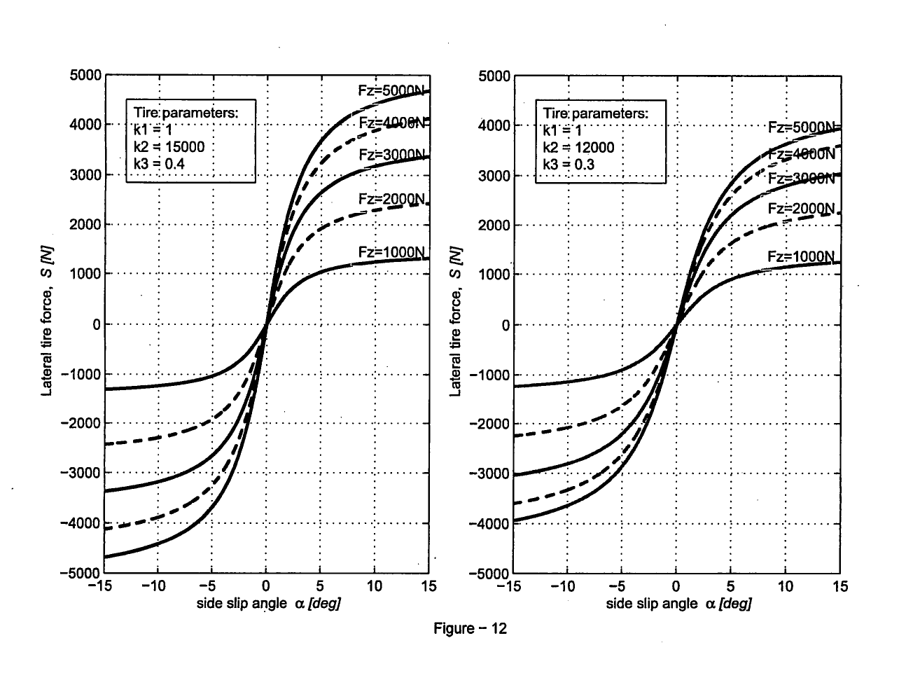

In step 1 of FIG. 9, we construct 16 models a-priori, whose state variables are βᵢ and \dot{ψ}ᵢ, and where i=1, 2, . . . , 16. These models of the form (20) are initialized such that each model corresponds to a fixed and predetermined level of cornering stiffness reduction in any combinations of the tires. In this case one needs 16 models (including the nominal model with no tire failures) which correspond to all different combinations of tire failures (in the predetermined levels) in each of the tires; this is illustrated in FIG. 11. In order to model the reduction of nonlinear cornering stiffnesses, we choose the parameters k₁ᵢⱼ, k₂ᵢⱼ, k₃ᵢⱼ for i={v,h} and j={l,r} accordingly in these 16 models. In FIG. 12 we provide two examples to demonstrate the nonlinear lateral tire force variation as a function of changing vertical loads and changing sideslip angles, as described in equation (21), for two different tire setups. For example, the variation on the left side of FIG. 12 can be considered to be a nominal tire force variation, whereas the right side plot can be considered to be a pressure compromised tire force variation.

The postulated model structure can eventually be expressed as follows:

$$\dot{{β}_{i}} = \frac{1}{mv} [ {S}_{vl , i} + {S}_{vr , i} + {S}_{hl , i} + {S}_{hr , i} ] - {\dot{ψ}}_{i} \\ \ddot{{ψ}_{i}} = \frac{1}{{J}_{zz}} [ ( {S}_{vl , i} + {S}_{vr , i} ) {l}_{v} - ( {S}_{hl , i} + {S}_{hr , i} ) {l}_{h} ] \qquad ( 22 )$$

$$\begin{matrix}{S}_{vl , i} = ( {k}_{1 vl , i} - \frac{{F}_{Zvl}}{{k}_{2 vl , i}} ) {F}_{Zvl} arctan ( {k}_{3 vl , i} {α}_{vl} ) \\ {S}_{vr , i} = ( {k}_{1 vr , i} - \frac{{F}_{Zvr}}{{k}_{2 vr , i}} ) {F}_{Zvr} arctan ( {k}_{3 vr , i} {α}_{vr} ) \\ {S}_{hl , i} = ( {k}_{1 hl , i} - \frac{{F}_{Zhl}}{{k}_{2 hl , i}} ) {F}_{Zhl} arctan ( {k}_{3 hl , i} {α}_{hl} ) \\ {S}_{hr , i} = ( {k}_{1 hr , i} - \frac{{F}_{Zhr}}{{k}_{2 hr , i}} ) {F}_{Zhr} arctan ( {k}_{3 hr , i} {α}_{hr} )\end{matrix} \} \qquad ( 23 )$$

where i=1, 2, . . . , 16. Furthermore, the method assumes zero initial conditions for each identification model, that is βᵢ(0)=0 and \dot{ψ}ᵢ(0)=0 for i=1, 2, . . . , 16.

In Step 2 of FIG. 9, the steering angle (δ), the vehicle velocity (v), the lateral acceleration (a_{y}), and the yaw rate \dot{ψ} are measured using the available vehicle sensors.

In Step 3 of FIG. 9, given the measurement of lateral acceleration (a_{y}), and provided suitable estimates of the longitudinal position of CG (lᵥ, lₕ), the CG height (h), and the vehicle mass (m), individual vertical tire forces corresponding to each tire are computed according to the following relations:

$$\begin{matrix}{F}_{Zvl} = \frac{{ml}_{h}}{2 L} g - \frac{{ml}_{h} h}{LT} {a}_{y} \\ {F}_{Zvr} = \frac{{ml}_{h}}{2 L} g + \frac{{ml}_{h} h}{LT} {a}_{y} \\ {F}_{Zhl} = \frac{{ml}_{v}}{2 L} g - \frac{{ml}_{v} h}{LT} {a}_{y} \\ {F}_{Zhr} = \frac{{ml}_{v}}{2 L} g + \frac{{ml}_{v} h}{LT} {a}_{y}\end{matrix} \} \qquad ( 24 )$$

which are derived assuming a constant longitudinal vehicle speed to be consistent with the assumptions of equation (20).

In Step 4 of FIG. 9, the steering column angle δ is used to compute the asymmetric steering angles for the inner and outer front wheels δᵢₙₙₑᵣ and δₒᵤₜₑᵣ, respectively, as in equation (14) from the third embodiment.

In Step 5 of FIG. 9, the inner and outer steering angles δᵢₙₙₑᵣ and δₒᵤₜₑᵣ, the vehicle velocity v, and the yaw rate \dot{ψ}ᵢ are used to compute the tire sideslip angles at each wheel depending on the turning direction as in equations (15a) and (15b) from the third embodiment.

In Step 6 of FIG. 9, the measured vehicle velocity v, calculated lateral tire forces Sᵢⱼ (according to (23)) along with the estimates of lᵥ, and m are used to calculate βᵢ(t), \dot{ψ}ᵢ(t) for each model using:

$$\begin{matrix}\dot{{β}_{i}} = \frac{1}{mv} [ {S}_{vl , i} + {S}_{vr , i} + {S}_{hl , i} + {S}_{hr , i} ] - {\dot{ψ}}_{i} \\ \ddot{{ψ}_{i}} = \frac{1}{{J}_{zz}} [ ( {S}_{vl , i} + {S}_{vr , i} ) {l}_{v} - ( {S}_{hl , i} + {S}_{hr , i} ) ( L - {l}_{v} ) ]\end{matrix} \} \qquad ( 25 )$$

where (βᵢ(t), \dot{ψ}ᵢ(t)) is the state pair for the i-th model. Using this state pair one can further compute the lateral acceleration output a_{y,i}(t) corresponding to each model from:

$${a}_{y , i} = v [ {\dot{β}}_{i} + {\dot{ψ}}_{i} ] = \frac{1}{m} [ {S}_{vl , i} + {S}_{vr , i} + {S}_{hl , i} + {S}_{hr , i} ] \qquad ( 26 )$$

In Step 7 of FIG. 9, given vehicle sensor measurements a_{y} and \dot{ψ}, the identification error eᵢ(t) corresponding to the i-th model is calculated using equation (2) from the first embodiment.

In Step 8 of FIG. 9, the cumulative identification error Jᵢ(t) corresponding to the i-th model identification error is calculated using equation (3) from the first embodiment.

In Step 9 of FIG. 9, the model with the least cumulative identification error is calculated using equation (4) of the first embodiment.

Note that from the selected model with the index i*, the instantaneous tire stiffness variations corresponding to each tire can be obtained from:

$$\begin{matrix}{C}_{vl} ( t ) = {C}_{vl , {i}^{*}} ( {F}_{Zvl} ) = \frac{{S}_{vl , {i}^{*}}}{{α}_{vl , {i}^{*}}} , {C}_{vr} ( t ) = {C}_{vr , {i}^{*}} ( {F}_{Zvr} ) = \frac{{S}_{vr , {i}^{*}}}{{α}_{vr , {i}^{*}}} \\ {C}_{hl} ( t ) = {C}_{hl , {i}^{*}} ( {F}_{Zhl} ) = \frac{{S}_{hl , {i}^{*}}}{{α}_{hl , {i}^{*}}} , {C}_{hr} ( t ) = {C}_{hr , {i}^{*}} ( {F}_{Zhr} ) = \frac{{S}_{hr , {i}^{*}}}{{α}_{hr , {i}^{*}}}\end{matrix} \} \qquad ( 27 )$$

where t denotes the instant of time.

In a further embodiment of the method depicted in FIG. 9, more sets of 16 models based on equations (22) and (23) and as described in FIG. 11 can be used, where each set of 16 models are initialized with different nonlinear lateral tire force characteristics as determined by the parameters k₁ᵢⱼ, k₂ᵢⱼ, k₃ᵢⱼ for i={v,h} and j={l,r}. In this way varying levels of tire failures resulting from pressure drop and/or thread wear can be detected.

A further variation of the described estimation methods can be obtained when one considers the friction variations in the road surface. It is known that road friction may change depending on the type of surface that the car is on, and this will affect the amount of lateral traction available. A further multiplier in equation (23) may be included to take the road friction changes into account. It is known that modern braking systems such as ABS can provide estimations of the road friction coefficient and given this information more refined estimations can be achieved.

Both of the third and fourth embodiments can be extended to deal with mass variability by incorporating additional models in equation (17) and (23). To this end, the method first determines a set [symbol] ={m₁, m₂, . . . , mₖ} denoting the mass variations of interest. For example, m₁ may denote the weight of the vehicle with one passenger, m₂ with two passengers, and so forth. Then, the models described in equation (17) and (23) are modified to take variable mass into account.

1. A method for determining the position of the centre of gravity of a vehicle in three dimensions comprising:
a. constructing a plurality of models of vehicle behaviour, each model including a plurality of known and unknown parameters that determine vehicle behaviour including parameters that define the position of the centre of gravity;
b. measuring vehicle behaviour during operation of the vehicle;
c. comparing measured vehicle behaviour with behaviour predicted by the models; and
d. determining which of the models most effectively predicts behaviour of the vehicle.

2. A method according to claim 1 in which the models include an unknown parameter that defines the vertical height of the centre of gravity.

3. A method according to claim 1 in which the models include an unknown parameter that defines the horizontal position of the centre of gravity.

4. A method according to claim 1 in which the models include at least one known parameter that defines a constant property of the vehicle.

5. A method according to claim 4 in which the known parameters include one or more of roll and pitch spring stiffnesses, and suspension damping coefficients.

6. A method according to claim 1 in which roll, pitch spring stiffnesses and suspension damping coefficients are unknown parameters.

7. A method according to claim 1 in which the unknown parameters include tyre parameters and vehicle loading.

8. A method according to claim 1 in which measured vehicle behaviour is determined from data received from sensors deployed upon the vehicle.

9. A method according to claim 1 in which measured vehicle behaviour includes one or more of steering angle, lateral acceleration, longitudinal acceleration, speed and yaw rate.

10. A method according to claim 1 in which measured vehicle behaviour includes roll angle and roll rate.

11. A method according to claim 1 in which measured vehicle behaviour includes pitch angle, and pitch rate.

12. A method according to claim 1 in which comparing measured vehicle behaviour with behaviour predicted by the models includes calculating for each model an error value that quantifies the inaccuracy of the model.

13. A method according to claim 10 in which determining which of the models most effectively predicts behaviour of the vehicle includes selecting the least error value.

14. A method for determining the lateral shift of the centre of gravity of a vehicle comprising determining the height of the centre of gravity, measuring the roll angle φ_{offset} of the vehicle and calculating the amount by which the centre of gravity must be laterally offset to produce that amount of roll.

15. A method according to claim 14 in which the height of the centre of gravity is determined by a method according to claim 1.

16. A method according to claim 14 in which the lateral offset of the centre of gravity is calculated as
$$y = \frac{k {φ}_{offset}}{mg cos ( {φ}_{offset} )} - h tan ( {φ}_{offset} ) .$$

17. A method of determining the tire conditions of a vehicle comprising:
a. constructing a plurality of models of vehicle behaviour, each model being associated with one or more tires having varying cornering stiffness;
b. measuring vehicle behaviour during a cornering manoeuvre of the vehicle;
c. comparing measured vehicle behaviour with behaviour predicted by said models; and
d. determining which of said models most effectively predicts the behaviour of the vehicle.

18. A method according to claim 17 in which each model is further associated with a specific vertical load on each tire.

19. A method according to claim 18 wherein said vertical load is calculated as a function of vehicle mass, lateral acceleration and vehicle centre of gravity.

20. A method according to claim 19 comprising calculating said vehicle centre of gravity according to the method of claim 1.

21. A method according to claim 18 comprising calculating sideslip at each tire as a function of vehicle steering angle, sideslip at the vehicle centre of gravity, yaw rate and vehicle velocity.

22. A method according to claim 17 comprising:
measuring vehicle speed and steering angle;
computing lateral acceleration and yaw rate for each model;
computing an identification error for each model based on said measured lateral acceleration and yaw rate; and
selecting the model having a minimum cost function based on said identification error at a given time instant to infer the tire conditions associated with said model.

23. A method according to claim 17 wherein each model is associated with one of over/under inflation of one or more tires; a particular level of tire wear; a particular type of tire; a particular type of wheel; or any combination thereof.
